(19) United States
(12) Patent Application Publication
(10) Pub. No.: US 2010/0194073 A1
(43) Pub. Date: Aug. 5, 2010

(54) MECHANICAL LINKAGES BETWEEN MOVING MACHINE PARTS

(76) Inventor: Graham Corbin, Cambridgeshire (GB)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 12/679,689

(22) PCT Filed: Sep. 17, 2008
(86) PCT No.: PCT/GB08/50835

§ 371 Date: Mar. 24, 2010

(30) Foreign Application Priority Data
Oct. 1, 2007 (GB) 0719091.1
Sep. 17, 2008 (GB) PCT/GB2008/050835

(51) Int. Cl. B62L 3/02; F16C 1/16; B62K 21/06; F16C 11/04; B62K 21/18; B62K 23/02

(52) U.S. Cl. 280/279; 403/78

(57) ABSTRACT

Conventional linkages between bicycle handlebar-mounted controls and rear brakes and gears are unable to accommodate unlimited rotation of the handlebars as is required on some so-called “freestyle” bicycles. A prior attempt to solve the problem employs a linkage comprising a bearing having two parts that are relatively rotatable about an axis. However this proposal is unable to handle situations where there are two or more mechanisms to be controlled e.g. a rear brake and a gear. Another problem is that dirt between the bearing surfaces may cause the bearing to jam. The invention provides pins (15C) that fit into slots (8A) for restricting rotation, relative to the handlebars, of a first bearing part (15A) and pins (15F) that fit in slots (9A) for restricting rotation, relative to the bicycle frame, of a second bearing part (15B). The aforementioned slots are formed in cylindrical guide walls not visible in FIG. 5. The use of the bearing (15) avoids any twisting of Bowden cables (7A, 7B) or the like such as are used on conventional linkages and, if any grit were to find its way between the two parts (15A, 15B) of the bearing, the latter are nevertheless forced to rotate relative to each other thus avoiding seizing of the bearing. The invention is not exclusively applicable to bicycles and can be used in linkages between parts of robotic machinery and other equipment.

This invention relates to a mechanical linkage designed to act between relatively rotating machine parts for example the frame of a bicycle and a stem that supports the handlebars and front wheel fork. More particularly, the invention concerns a controlling mechanism fixed relative to one of the machine parts and a controlled mechanism fixed relative to the other machine part. In the aforementioned example of a bicycle, the “controlling mechanism” usually includes some form of lever whilst the “controlled mechanism” is usually a brake or gear.

Because the front wheel of a bicycle needs to swivel relative to the frame, the linkage must accommodate this swivelling movement. U.S. Pat. No. 4,653,768 describes one way in which this can be done for a single rear brake by employing a rotating bearing surrounding a steering stem of the bicycle. This allows unlimited rotation of the handlebars. A problem with this technique is that it does not provide for the possibility of using two or more controls e.g. for a rear brake and gear, or a rear brake and two gears. Furthermore, ingress of dirt or other unwanted material between the bearing surfaces may cause the bearing to jam, resulting in unintentional operation of the rear brake.

According to the invention there is provided a control device for a machine having a first and second machine parts pivoted about an axis with respect to each other, the control device comprising a mechanical linkage designed to act between a controlling mechanism fixed relative to the first part and a controlled mechanism fixed relative to the second part, the linkage comprising a bearing having two parts relatively rotatable about the axis and connected respectively to the controlling and controlled mechanisms characterised by means for restricting rotation relative to the first machine part of a first bearing part connected to the controlling mechanism, and means for restricting rotation relative to the second machine part of a second bearing part connected to the controlled mechanism.

By restricting rotation of the bearing parts relative to the respective machine parts in this way it becomes more difficult or impossible for the bearing to jam because its two parts are constrained to rotate with the corresponding relative rotation of the two machine parts.

The undesired rotation of the bearing parts relative to their corresponding machine parts can be avoided by the use of guides having axially directed slots that receive corresponding pins on the bearing parts. The location of the pins in these slots allows axial movement of the bearing whilst ensuring that they rotate respectively with the steering stem and the frame. The result is that there is no flexing of Bowden cables or equivalent linkages, which flexing would otherwise tend to interfere with the smooth operation of the device. Also, if any grit were to find its way between the two parts, they are nevertheless forced to rotate relative to each other thus avoiding seizing of the bearing.

In one construction in accordance with the invention the guides are formed by co-axial cylinders, one within the other, and defining a channel of annular cross-section between them. By employing more than two such cylinders it becomes possible to define more than one such guide channel for receiving respective bearings. This makes it possible to control two or more different mechanisms such as brake and gears. These cylinders can all be located within the head tube of the bicycle, this feature making for a particularly neat configuration.

One way in which the invention may be performed will now be described by way of example with reference to the accompanying drawings in which:—

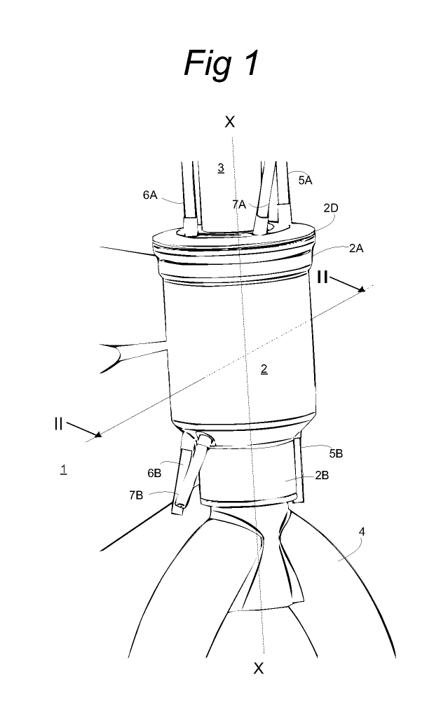

FIG. 1 is a perspective view of the head tube of a bicycle having a control device constructed in accordance with the invention, showing parts of the front wheel fork and stem;

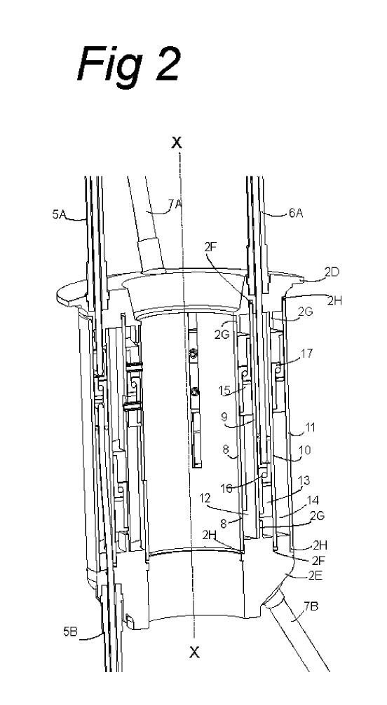

FIG. 2 is a perspective view of internal parts of the head tube of FIG. 1 shown partly as an cross-section down the axis X-X and through the line II-II of FIG. 1;

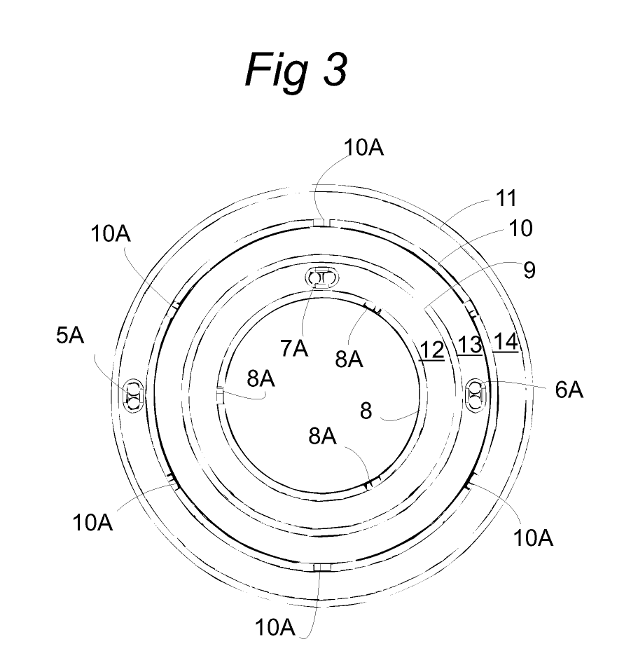

FIG. 3 is a plan view of the components shown in FIG. 2 with its top bearing support removed to reveal internal support cylinders, other internal components being not shown in this drawing;

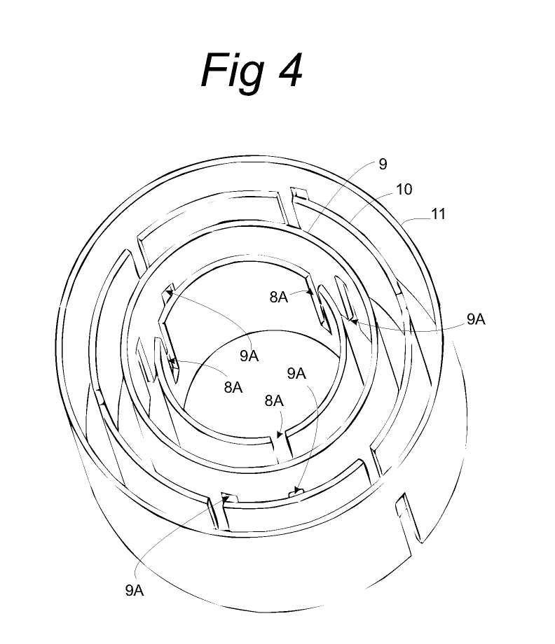

FIG. 4 is a perspective view of just the internal support cylinders of FIG. 3; and

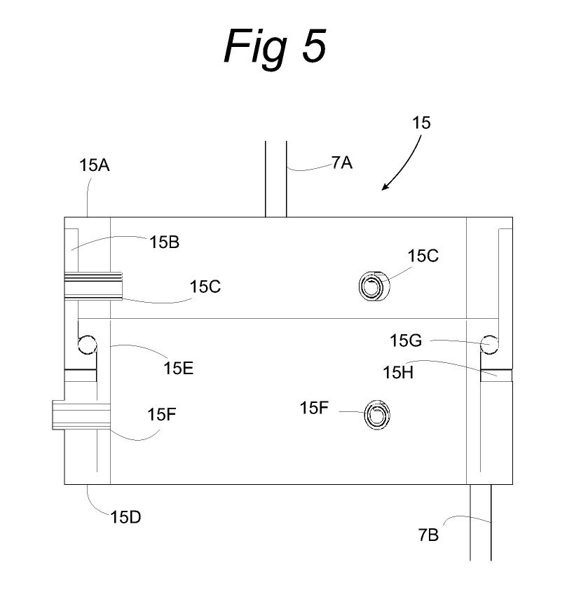

FIG. 5 is a detailed axial cross-section through one of the linkage bearings visible in less detail on FIG. 2.

Referring first to FIG. 1, the illustrated bicycle comprises a frame 1 including a head tube 2 carrying an upper main bearing assembly 2A and a lower main bearing assembly 2B. A steering stem 3 passes through the head tube and rotates in these main bearings about an axis X-X. The stem 3 carries a front wheel fork 4 and handlebars (not shown).

A rear brake linkage comprises a manual control (not shown) mounted on the handlebars and connected to an upper Bowden cable 7A. This is linked via a linkage bearing to be described later, to a lower Bowden cable 7B which leads to a rear brake mechanism of the bicycle.

A gear linkage comprises a manual control (not shown) also mounted on the handlebars and connected to an upper Bowden cable 6A. This is linked via a linkage bearing to be described later, to a lower Bowden cable 6B which leads to a gear mechanism.

A second gear linkage comprises a manual control (not shown) also mounted on the handlebars and connected to an upper Bowden cable 5A. This is linked via a linkage bearing to be described later, to a lower Bowden cable 5B which leads to a second gear mechanism.

Referring now to FIGS. 2, 3 and 4, the upper main bearing 2A has a part 2D which receives the upper Bowden cables 5A, 6A and 7A and has a conical central opening by which it is clamped to the stem 3 (not shown in FIG. 2) by a compression fitting, also not shown. A lower conical casing 2E of the head tube receives the lower Bowden cables 5B, 6B, and 7B (6B not shown). The parts 2D and 2E are formed with circular grooves 2F, lips 2G and recesses 2H which serve to locate, co-axially with respect to the head tube, four cylindrical guides 8, 9 and 10 and 11 of progressively increasing diameter. The guides 8 and 10 are fixed relative to the part 2D and therefore rotate with the handlebars, whilst the guides 9 and 11 are fixed relative to the part 2E and therefore relative to the head tube and frame of the bicycle. The guide 11 fits snugly within the head tube 2, the latter being not shown in FIG. 2.

The cylindrical supports 8, 9, 10 and 11 define, between them, three vertical channels 12, 13 and 14 of annular cross-section in which are guided three axial annular ball bearings 15, 16 and 17. The bearings 15, 16 and 17 all have the same axial position when mid-way between their extremes of movement. FIG. 2 shows the bearing 16 lower than the others as a result of operation of one or more of the controls. These bearings are all designed to transmit mainly axial forces.

FIG. 5 illustrates, by way of example, the bearing 15, the other bearings being similar except for their diameter. This bearing 15 has an upper ring 15A attached to the cable 7A and having its outer cylindrical surface formed with a recess into which fits a ball race 15B. The parts 15A and 15B have bores and are locked together by three roll pins 15C that pass through these bores to form a top part of the bearing. The bearing also has a lower ring 15D which is attached to cable 7B and has its inner surface formed with a recess into which fits a ball race 15E. The parts 15D and 15E are locked together by three roll pins 15F to form a bottom part of the bearing. Balls 15G are held between the races 15B and 15E and a washer 15H fits between the top and bottom parts 15B and 15D to transmit compression forces through the bearing.

The roll pins 15C project inwardly, from an inner surface of the ring 15A, into three respective slots 8A in the guide cylinder 8. Because the guide cylinder 8 is fixed in relation to the handlebars, this ensures that the top half of the bearing 15, comprising parts 15A and 15B, rotates with the handlebars and does not snag in the space 12.

The roll pins 15F project outwardly, from an outer surface of the ring 15D, into three respective slots 9A in the guide cylinder 9. Because the guide cylinder 9 is fixed in relation to the frame, this ensures that the bottom half of the bearing 15, comprising parts 15D and 15E does not rotate relative to the frame and does not snag in the space 12.

The construction of bearings 16 and 17 and the method by which they are guided in spaces 13 and 14 without snagging is similar to that of bearing 15. The only differences are the diameters of the bearings and the selection of which roll pins project inwardly and outwardly, this always being selected so that the lower bearing part (connected to the brake or gear to be controlled) has its pins projecting into the slots of a cylinder fixed relative to the frame whilst the upper bearing part (connected to the manually manipulatable control mechanism) has its pins projecting into the slots of a cylinder fixed relative to the steering stem. It will be noted that, whilst the inner and outer cylinders 8 and 11 require only three slots to receive pins of the lower and upper parts of bearings 15 and 17 respectively, the intermediate cylinder 9 requires six slots to guide the lower parts of bearings 15 and 16; and the intermediate cylinder 10 likewise requires six slots to guide the upper parts of bearings 16 and 17.

In operation, when tension is applied to the brake cable 7A the bearing part 15A is lifted, being guided by the walls of the channel 12 and by the action of the pins 15C within corresponding slots 8A which allows axial movement whilst constraining the part 15A to rotate with the handlebars even if any grit or other unwanted material or influences is/are present that would otherwise interfere with the frictionless rotation of the part 15. Expressed another way, rotation of the part 15A with respect to the handlebars is prevented by the slots 8A. Because of this action there is no flexing of the Bowden cable 7A during the rotation of the handlebars, which flexing might otherwise have the effect of applying forces liable to cause canting of the bearing 15 and consequential jamming or snagging of the bearing 15 in the channel 12. It also avoids inadvertent operation of the brake.

Upward movement of the bearing parts 15A and 15B cause the parts 15E and 15D also to rise within the channel 12, tensioning the Bowden cable 7B and thereby operating the rear brakes. The action of the pins 15F in the slots 9A prevents the part 15D from rotating relative to the frame even if any grit or other unwanted material or influences is/are present that would otherwise interfere with the frictionless rotation of the part 15D. Because of this action there is no flexing of the Bowden cable 7B during the rotation of the handlebars, which flexing might otherwise have the effect of applying forces liable to cause canting of the bearing and consequential jamming or snagging of the bearing in the channel 12. This action also prevents the risk that turning of the handlebars might inadvertently operate the brake.

Operation of both sets of gears follows the same principles as described for the rear brake system.

The use of the concentric guide cylinders makes it possible to employ two or more bearings located one within the other in a compact configuration that will fit within the head tube and allows 360 degree rotation and more of the steering column whilst ensuring that reliable smooth independent operation of the controls can take place without risk of the bearings jamming even in the presence of grit or dirt. Because flexing of the cables does not occur it is possible in alternative constructions to employ non-flexible couplings that may include mechanical, electro-mechanical, hydraulic or pneumatic components, in place of the Bowden cables.

Although the invention has been particularly described in relation to a bicycle, the same principles can equally well be used in other machines, including robotic and agricultural machines where more than one mechanical control linkage is required to pass between two relatively rotating parts.

1-9. (canceled)

10. A control device for a machine having first and second machine parts pivoted about an axis with respect to each other, said control device comprising:
a mechanical linkage designed to act between a controlling mechanism fixed relative to said first part and a controlled mechanism fixed relative to said second part, said linkage comprising a bearing having two parts relatively rotatable about said axis and connected respectively to said controlling and controlled mechanisms, wherein each bearing part has a projection;
a first guide fixed relative to said first machine part and having a slot which receives said projection of said first bearing part for restricting rotation thereof relative to said first guide; and
a second guide fixed relative to said second machine part and having a slot which receives said projection of said second bearing part for restricting rotation thereof relative to said second guide.

11. The control device according to claim 10, wherein said first and second guides are defined by cylindrical members co-axial with respect to said axis.

12. The control device according to claim 11, wherein said cylindrical members define a channel between them in which said bearing is guided for axial movement.

13. The control device according to claim 12 further comprising:
at least one further bearing having two parts relatively rotatable about said axis and connected respectively to further controlling and controlled mechanisms;
means for restricting rotation relative to said first machine part of a first bearing part of said further bearing connected to said further controlling mechanism; and
means for restricting rotation relative to said second machine part of a second bearing part of said further bearing connected to said second machine part;
wherein said bearing and said further bearing being located at different radial distances from said axis.

14. The control device according to claim 13, wherein said cylindrical members are at least an innermost cylindrical member, an intermediate cylindrical member, and an outermost cylindrical member, wherein said cylindrical members defining channels therebetween for respective bearings, said intermediate cylindrical member having at least two slots for receiving said projections on said bearings located respectively inside and outside said intermediate cylindrical member.

15. The control device according to claim 14, wherein said bearing and said further bearing each defines an annulus surrounding said axis.

16. The control device according to claim 15, wherein said first machine part includes a front wheel support of a bicycle, and said second machine part includes a frame of said bicycle.

17. The control device according to claim 16, wherein said bearings are enclosed within a head tube of said bicycle in which a steering stem is rotatably mounted.

18. The control device according to claim 13, wherein said controlled mechanism is selected from the group consisting of rear brakes, and gears.

19. A bicycle control device having first and second machine parts pivoted about an axis with respect to each other, said bicycle control device comprising:
a mechanical linkage designed to act between a controlling mechanism fixed relative to said first part and a controlled mechanism fixed relative to said second part, said linkage comprising a bearing having two parts relatively rotatable about said axis and connected respectively to said controlling and controlled mechanisms, wherein each bearing part has a projection;
a first guide fixed relative to said first machine part and having a slot which receives said projection of said first bearing part for restricting rotation thereof relative to said first guide;
a second guide fixed relative to said second machine part and having a slot which receives said projection of said second bearing part for restricting rotation thereof relative to said second guide; and
at least one further bearing having two parts relatively rotatable about said axis and connected respectively to further controlling and controlled mechanisms;
means for restricting rotation relative to said first machine part of a first bearing part of said further bearing connected to said further controlling mechanism; and
means for restricting rotation relative to said second machine part of a second bearing part of said further bearing connected to said second machine part;
wherein said bearing and said further bearing being located at different radial distances from said axis.

20. The bicycle control device according to claim 19, wherein said first and second guides are defined by cylindrical members co-axial with respect to said axis.

21. The bicycle control device according to claim 20, wherein said cylindrical members define a channel between them in which said bearing is guided for axial movement.

22. The bicycle control device according to claim 21, wherein said cylindrical members are at least an innermost cylindrical member, an intermediate cylindrical member, and an outermost cylindrical member, said cylindrical members defining channels therebetween for respective said bearing and further bearing, said intermediate cylindrical member having at least two slots for receiving said projections on said bearing and further bearing located respectively inside and outside said intermediate cylindrical member.

23. The bicycle control device according to claim 22, wherein said bearing and said further bearing each defines an annulus surrounding said axis.

24. The bicycle control device according to claim 23, wherein said first machine part includes a front wheel support of a bicycle, and said second machine part includes a frame of said bicycle.

25. The bicycle control device according to claim 24, wherein said bearings are enclosed within a head tube of said bicycle in which a steering stem is rotatably mounted.

26. The bicycle control device according to claim 25, wherein said controlled mechanism is selected from the group consisting of rear brakes, and gears.
